(19) United States
(12) Patent Application Publication
(10) Pub. No.: US 2026/0129567 A1
(43) Pub. Date: May 7, 2026

(54) D2C Satellite Mode Smart Selection Between Non-Terrestrial Network And Terrestrial Network

(71) Applicant: MediaTek Singapore Pte. Ltd., Singapore (SG)

(72) Inventors: Hung-Yueh Chen, Gyeonggi-do (KR); Byeng Hyun Kim, Gyeonggi-do (KR); Jung Shup Shin, Gyeonggi-do (KR); Hyoyoung Lee, Gyeonggi-do (KR); Ren-Huang Liu, Hsinchu City (TW); Ju Young Jung, San Jose, CA (US); Prathik Ananth Vinu, Bengaluru KA (IN); Sangho Park, Gyeonggi-do (KR); Moonjeong Choi, Gyeonggi-do (KR); Gi Jeong Park, Gyeonggi-do (KR); Pei-Tsung Wu, Hsinchu City (TW)

(21) Appl. No.: 19/297,321

(22) Filed: Aug. 12, 2025

(30) Foreign Application Priority Data
Nov. 7, 2024 (IN) 202421085415

(51) Int. Cl. H04W 48/18; H04W 48/16; H04W 84/06; H04W 88/06

(52) U.S. Cl. CPC H04W 48/18; H04W 48/16; H04W 84/06; H04W 88/06

(57) ABSTRACT

Techniques pertaining to direct-to-cell (D2C) satellite mode selection between non-terrestrial network (NTN) and terrestrial network (TN) in wireless communications are described. An apparatus (e.g., user equipment (UE)) enters a satellite mode due to no terrestrial coverage. The apparatus then performs a procedure to shorten a search time or reduce power consumption, or both.

### CROSS REFERENCE TO RELATED PATENT APPLICATION(S)

The present disclosure is part of a non-provisional application claiming the priority benefit of India Patent Application No. 202421085415, filed 7 Nov. 2024, the content of which herein being incorporated by reference in its entirety.

### TECHNICAL FIELD

The present disclosure is generally related to wireless communications and, more particularly, to direct-to-cell (D2C) satellite mode selection between non-terrestrial network (NTN) and terrestrial network (TN) in wireless communications.

### BACKGROUND

Unless otherwise indicated herein, approaches described in this section are not prior art to the claims listed below and are not admitted as prior art by inclusion in this section.

In wireless communications such as mobile communications in accordance with the 3^{rd} Generation Partnership Project (3GPP) standards, D2C communication is poised to constitute a major part of next-generation mobile connectivity. In terms of available services, normal (terrestrial) services are expected to include data, voice, short message service (SMS), emergency calling and messaging, and user interface (UI). In contrast, limited (terrestrial) services would include only emergency calling and messaging, with limited UI showing emergency. On the other hand, phase 1 of satellite (non-terrestrial) services (Phase 1) would include SMS, emergency messaging, and UI for showing satellite mode (with services blocked). Moreover, phase 2 of satellite (non-terrestrial) services (Phase 2) would include data (slow), voice (low capacity), SMS, emergency calling and messaging, and UI showing satellite mode. Accordingly, the ranking of user experience in a descending order would be as follows: normal service (domestic and roaming)>satellite service (Phase 2)>limited services, which is about satellite service (Phase 1). For satellite service at Phase 1, its user experience ranking is low because of disadvantages such as, for example, no support for emergency calls, long latency, and low data rate. For satellite service at Phase 2, its user experience ranking is lower than that of normal service because of much-lower data rate and higher possibility of congestion for data and voice services. As such, in case that a user equipment (UE) camps on a satellite cell unexpectedly, the user experience is likely to be seriously impacted because of restricted service quality and obvious user interface (UI) notification. That is, when in the satellite mode, the UE changes its UI and restricts services, and this results in negatively impacted user experience.

Therefore, there is a need for a solution of D2C satellite mode selection between NTN and TN in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to D2C satellite mode selection between NTN and TN in wireless communications. It is believed that implementations of the various proposed schemes may address or otherwise alleviate the aforementioned issue(s).

In one aspect, a method may involve a UE entering a satellite mode due to no terrestrial coverage. The method may also involve the UE performing a procedure to shorten a search time or reduce power consumption, or both.

In another aspect, an apparatus may include a transceiver configured to communicate wirelessly and a processor coupled to the transceiver. The processor may enter the UE into a satellite mode due to no terrestrial coverage. The processor may also perform a procedure to shorten a search time or reduce power consumption, or both.

It is noteworthy that, although description provided herein may be in the context of certain radio access technologies, networks, and network topologies for wireless communication, such as 5^{th} Generation (5G)/New Radio (NR) mobile communications, 6^{th} Generation (6G) mobile communications and beyond, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which proposed schemes in accordance with the present disclosure may be implemented.

FIG. 2 is a diagram of an example scenario in which proposed schemes in accordance with the present disclosure may be implemented.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario in which proposed schemes in accordance with the present disclosure may be implemented.

FIG. 6 is a diagram of an example scenario under a proposed scheme in accordance with the present disclosure.

FIG. 7 is a diagram of an example scenario under a proposed scheme in accordance with the present disclosure.

FIG. 8 is a block diagram of an example communication system in accordance with an implementation of the present disclosure.

FIG. 9 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to D2C satellite mode selection between NTN and TN in wireless communications. According to the present disclosure, a number of possible solutions may be implemented separately or jointly. That is, although these possible solutions may be described below separately, two or more of these possible solutions may be implemented in one combination or another.

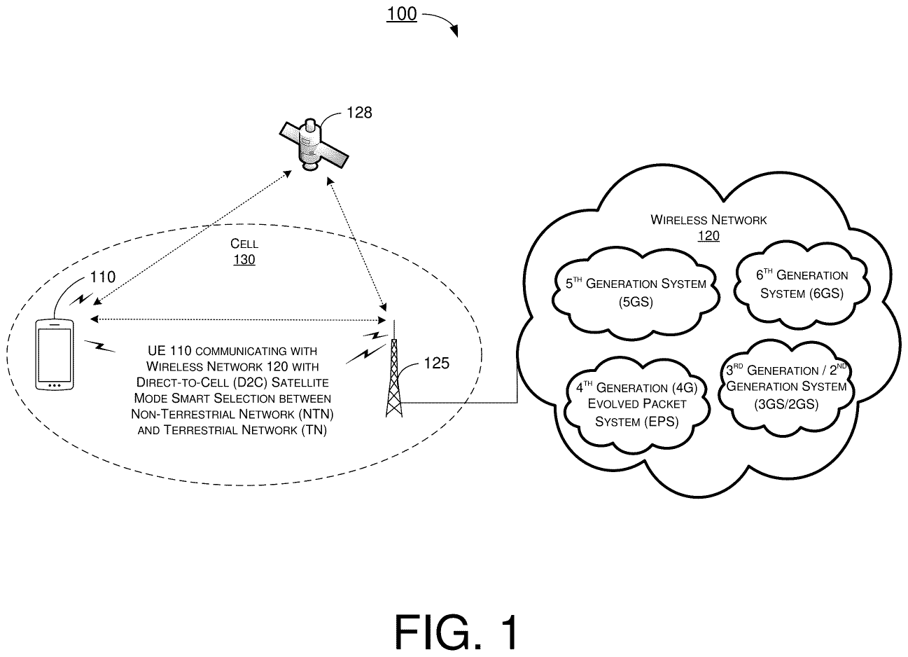

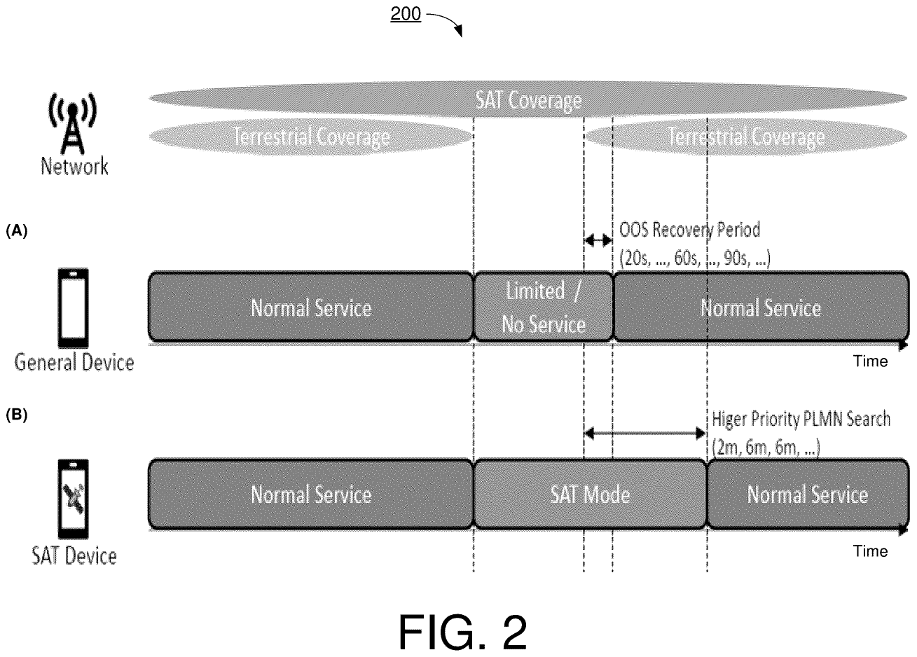

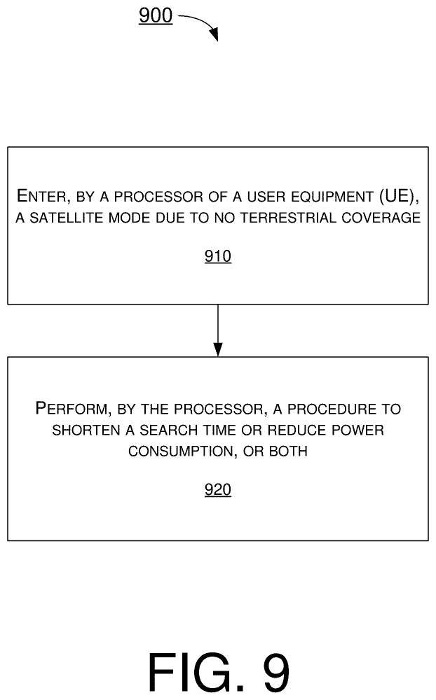

FIG. 1 illustrates an example network environment 100 in which various solutions and schemes in accordance with the present disclosure may be implemented. FIG. 2˜FIG. 9 illustrate examples of implementation of various proposed schemes in network environment 100 in accordance with the present disclosure. The following description of various proposed schemes is provided with reference to FIG. 1˜FIG. 9.

Referring to FIG. 1, network environment 100 may involve a UE 110, such as a mobile device or smartphone, in wireless communication with a wireless network 120 as part of a communication network. The wireless network 120 may be one or more public land mobile networks (PLMNs) including 5G/NR domain, 4G/LTE domain, and 6G domain. and a wireless network 120, which may include a 6^{th} Generation System (6GS), 5^{th} Generation System (5GS) and a 4^{th} Generation System (4GS) or EPS (and, optionally, 3^{rd} Generation System (3GS) and/or 2^{nd} Generation System (2GS)). Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to D2C satellite mode selection between NTN and TN in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 in which proposed schemes in accordance with the present disclosure may be implemented. Scenario 200 may pertain to an issue of late recovery from the satellite mode, in which only restricted services are available to UE 110, to normal services. For instance, a user of UE 110 may be traveling from a first region where both terrestrial coverage and non-terrestrial, or satellite, coverage are available to a second region where only satellite coverage is available, before reaching a third region where both terrestrial coverage and satellite coverage are available again.

In an event that UE 110 is a general device not capable of satellite communications, as shown in portion (A) of FIG. 2, UE 110 may experience a period with normal services while in the first region, followed by a period of limited or no service (e.g., out of service (OOS)) while in the second region, followed by a period of normal services while in the third region. The OOS recovery period may vary (e.g., 20 seconds, 60 seconds, 90 seconds, or else).

In an event that UE 110 is a capable of satellite communications, as shown in portion (B) of FIG. 2, UE 110 may experience a period with normal services while in the first region, followed by a period of satellite mode while in the second region, followed by a period of normal services while in the third region. While in the satellite mode, UE 110 may perform high-priority public land mobile network (PLMN) search(es) for a certain period of time (e.g., 2 minutes, 6 minutes, or else).

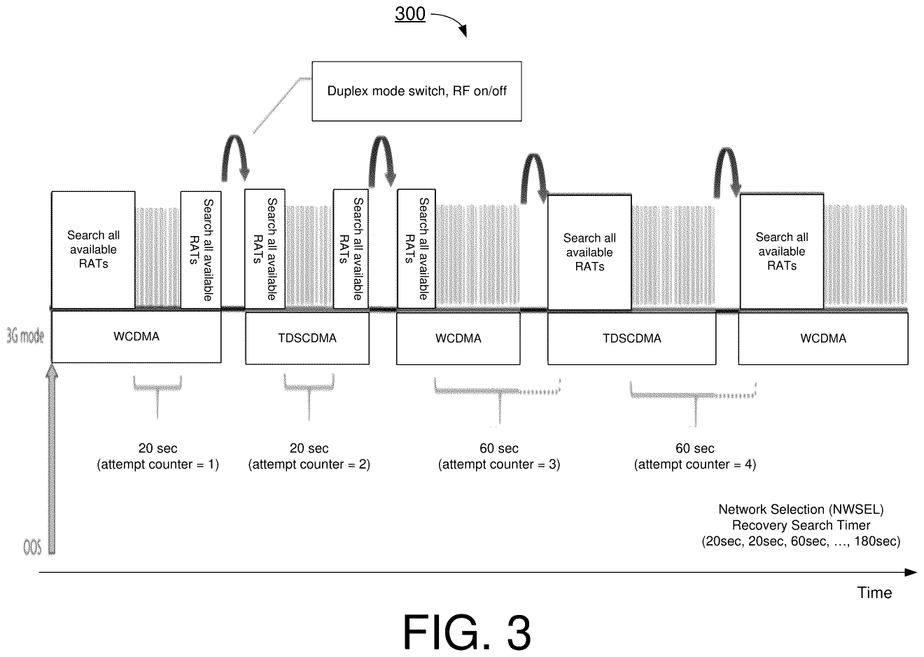

FIG. 3 illustrates an example scenario 300 under a proposed scheme in accordance with the present disclosure. Scenario 300 may pertain to Option A of optimization of UE performance regarding the issue of late recovery from the satellite mode. Under the proposed scheme, UE 110 may shorten the PLMN search time by applying a “satellite recovery procedure” instead of carrying out a “high priority PLMN search procedure.” The satellite recovery procedure may involve using the same timer design of an “OOS recovery procedure” and removing one or more unnecessary searches (e.g., removing the search of “any PLMN”).

Under the proposed scheme, in case that UE 110 supports dual subscriber identity module (SIM) dual access with data radio (DR-DSDA), meaning UE 110 is configured with two sets of radio frequency (RF) components, UE 110 may use the receiving (RX) component not being used to perform OOS recovery so as to avoid impacting the satellite mode procedure (e.g., receiving paging on one set of RF components while performing OOS recovery on the other set of RF components).

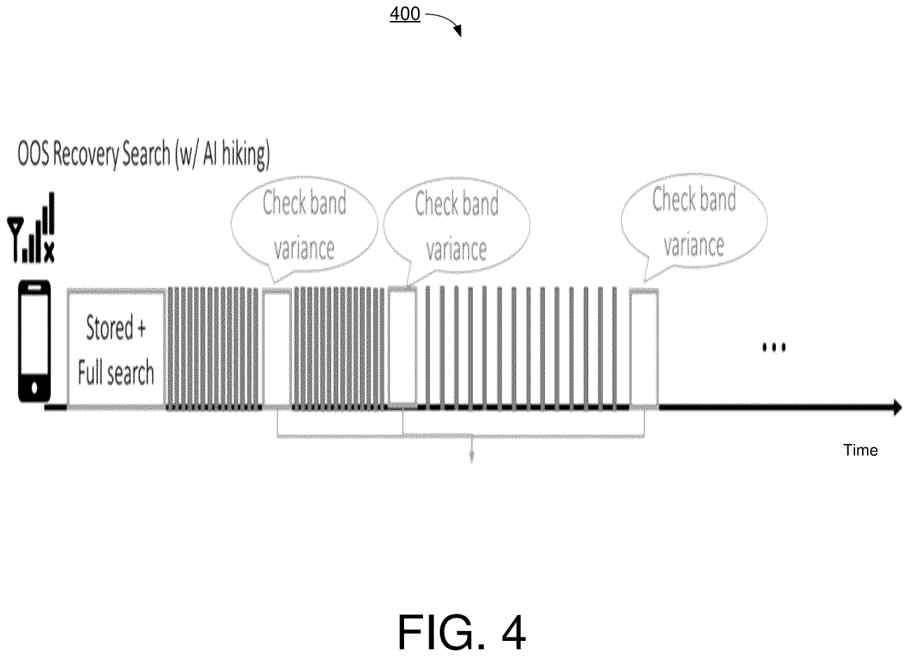

FIG. 4 illustrates an example scenario 400 under a proposed scheme in accordance with the present disclosure. Scenario 400 may pertain to Option B of optimization of UE performance regarding the issue of late recovery from the satellite mode. By default, UE 110 would normally perform a PLMN search based on a stored list of PLMNs and full band search, which would be power and time consuming. Under the proposed scheme, UE 110 may reduce power consumption by applying an “artificial intelligence (AI) satellite hiking mode.” For instance, UE 110 may apply the AI hiking mode when performing an OOS recovery search, while excluding the satellite band or frequency.

The term of “AI satellite hiking mode” herein refers to a mode in which UE 110 reduces its search range by detecting whether there is power variance in each searched band. In case there are no cells in a given area, it would be meaningless for UE 110 to perform a full band search in that area again. Thus, it may be assumed that the UE is staying in the same environment in case there is no variance in power scan status.

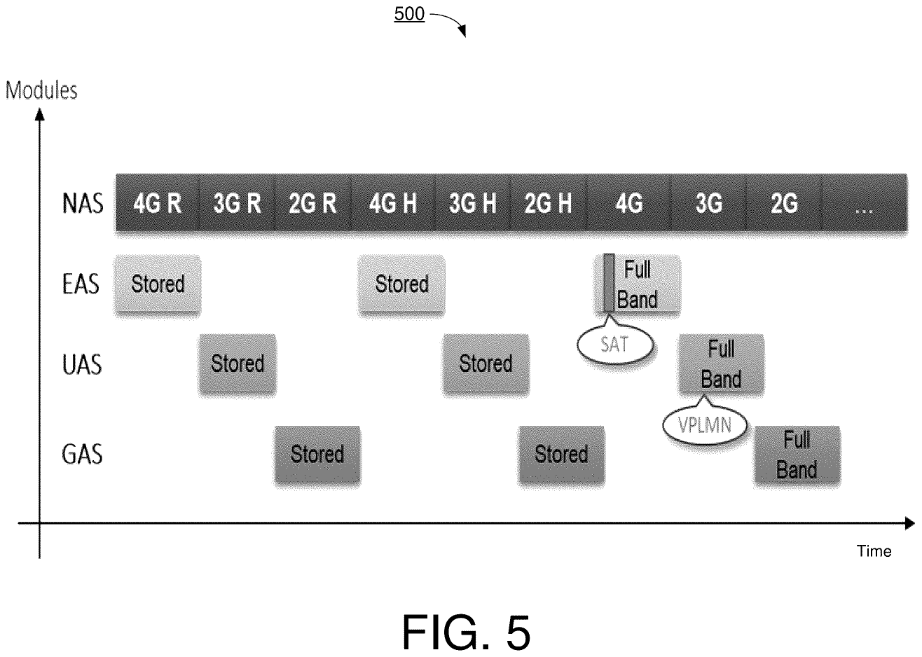

FIG. 5 illustrates an example scenario 500 in which proposed schemes in accordance with the present disclosure may be implemented. Scenario 500 may pertain to an issue of UE unexpectedly camping on a satellite PLMN. As alluded to above, for better user experience, UE 110 should camp on a visited PLMN (VPLMN), to receive normal services, rather than the satellite PLMN from which only restricted services are available. Nevertheless, UE 110 may still select the satellite PLMN unexpectedly. As a result, camping on the satellite PLMN would block data/voice services and cause serious degradation in user experience. Possible causes of this issue may include, for example: (1) old SIM with old configuration; (2) new satellite network deployment; (3) new roaming network deployment or configuration; and (4) delay or failure in SIM over-the-air (OTA) update.

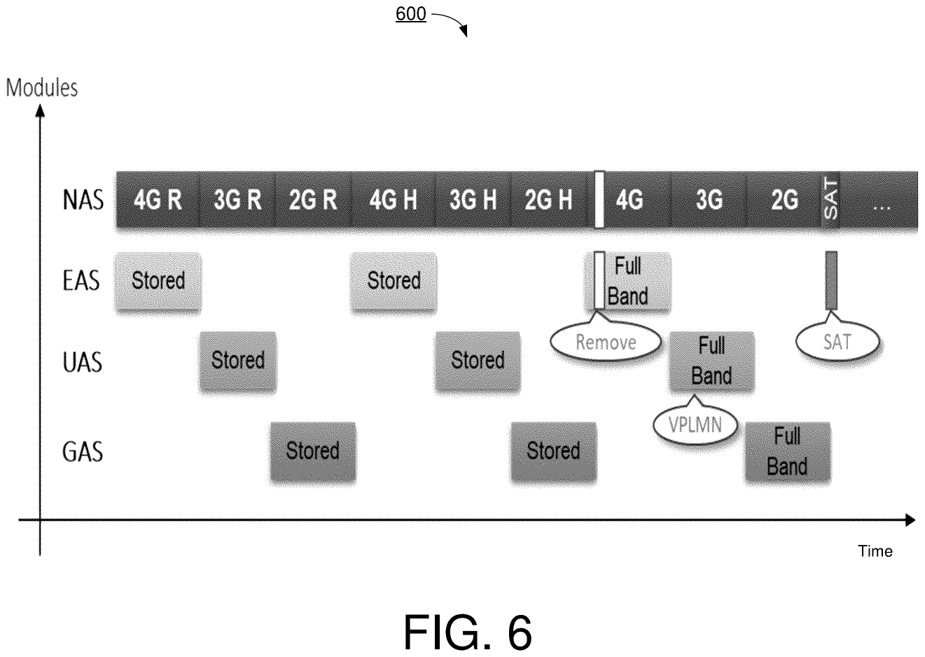

FIG. 6 illustrates an example scenario 600 under a proposed scheme in accordance with the present disclosure. Scenario 600 may pertain to Type 1 of Option C of optimized PLMN search sequence for satellite to address the issue of UE unexpectedly camping on a satellite PLMN. Under the proposed scheme, the satellite band/frequency is removed from a 4^{th} Generation (4G) full band scan and appended to the end of a 6^{th} Generation (6G)/5^{th} Generation (5G)/4G/3^{rd} Generation (3G)/2^{nd} Generation (2G) full band scan. This optimization may be optionally applied according to the SIM, location, and network environment (e.g., mobile country code (MCC) of a detected cell) of UE 110.

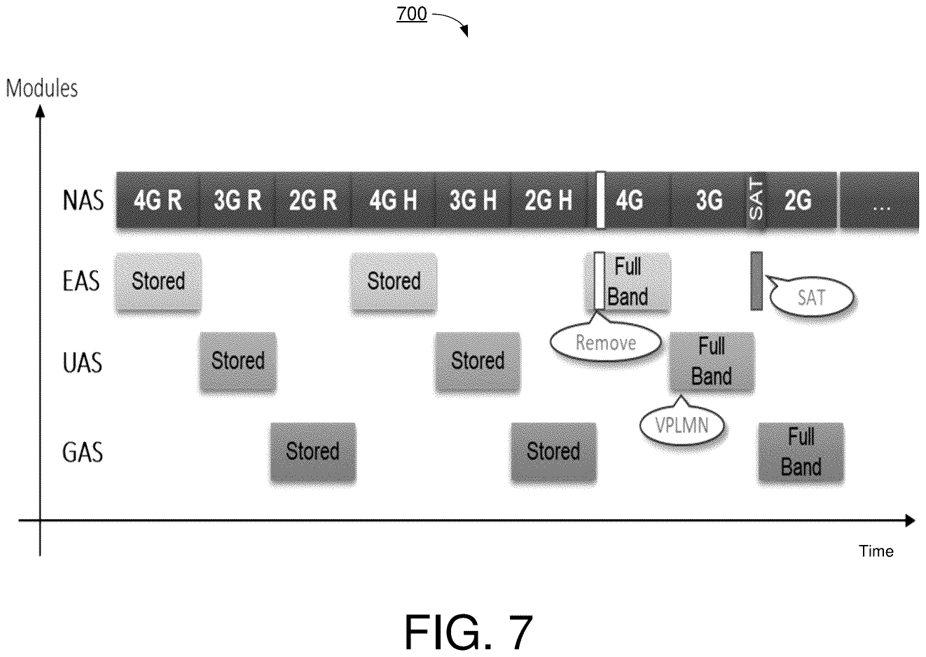

FIG. 7 illustrates an example scenario 700 under a proposed scheme in accordance with the present disclosure. Scenario 700 may pertain to Type 2 of Option C of optimized PLMN search sequence for satellite to address the issue of UE unexpectedly camping on a satellite PLMN. Under the proposed scheme, the satellite band/frequency is removed from the 4G full band scan and appended or otherwise inserted to the middle of a 6G/5G/4G/3G/2G full band scan. This optimization may be optionally applied according to the SIM, location, and network environment (e.g., mobile country code (MCC) of a detected cell) of UE 110.

It is noteworthy that, while both scenario 600 and scenario 700 involve changing the PLMN search sequence among satellite band/frequency and 6G/5G/4G/3G/2G band/frequency, in scenario 600 original equipment manufacturer (OEM) configuration and OTA software update may be required for implementation of the proposed scheme. In contrast, in scenario 700, UE 110 may perform dynamic adjustment by comparing the last time satellite service quality (e.g., where the data service is supported, data throughput, and voice quality) with the general service quality of 6G/5G/4G/3G/2G of a TN.

In view of the above, it is believed that one of ordinary skill in the art would appreciate the value of optimization for issues related to the satellite mode. Regarding the issue of late recovery from satellite mode to normal services, Option A may involve applying the OOS recovery procedure instead of the high-priority PLMN search procedure, and Option B may involve applying “AI satellite hiking mode” while excluding the satellite band/frequency. Regarding the issue of UE unexpectedly camping on a satellite PLMN instead of a terrestrial PLMN, Option C may involve performing an optimized PLMN search sequence.

### Illustrative Implementations

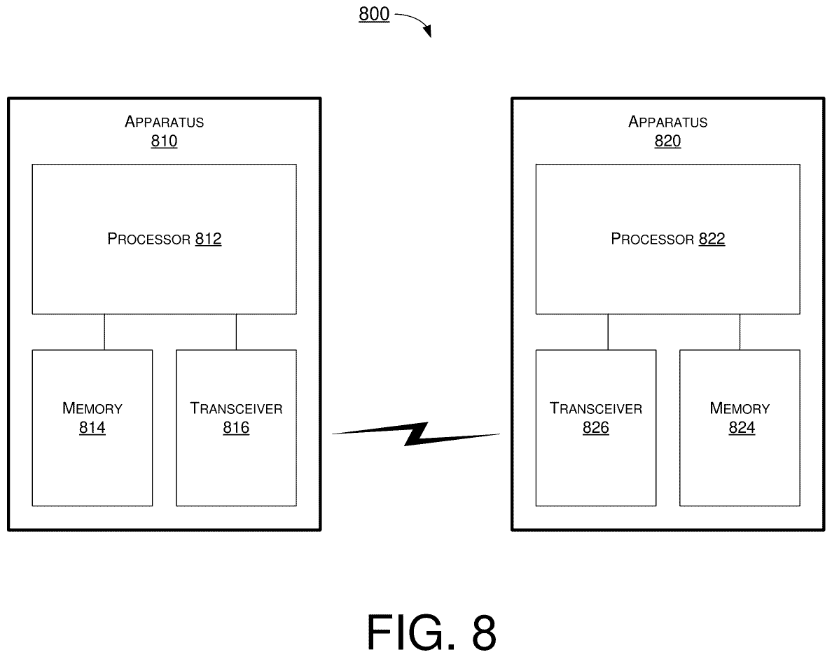

FIG. 8 illustrates an example communication system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to D2C satellite mode selection between NTN and TN in wireless communications, including the various schemes described above with respect to various proposed designs, concepts, schemes and systems, including network environment 100, as well as processes described below.

Each of apparatus 810 and apparatus 820 may be a part of an electronic apparatus, which may be a lab computer, a network apparatus (e.g., network node 125) or a UE (e.g., UE 110). The UE may be a portable or mobile apparatus, a wearable apparatus, a vehicular device or a vehicle, a wireless communication apparatus or a computing apparatus. For instance, either or both of apparatus 810 and apparatus 820 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in an eNodeB in an LTE, LTE-Advanced or LTE-Advanced Pro network or in a gNB or TRP in a 5G network, an NR network or an IoT network.

In some implementations, each of apparatus 810 and apparatus 820 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 810 and apparatus 820 may be implemented in or as a network apparatus or a UE. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC or RISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including those pertaining to D2C satellite mode selection between NTN and TN in wireless communications in accordance with various implementations of the present disclosure.

In some implementations, apparatus 810 may also include a transceiver 816 coupled to processor 812. Transceiver 816 may be capable of wirelessly transmitting and receiving data. In some implementations, transceiver 816 may be capable of wirelessly communicating with different types of wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for MIMO wireless communications. In some implementations, apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs/wireless networks of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, apparatus 810 may further include a memory 814 coupled to processor 812 and capable of being accessed by processor 812 and storing data therein. In some implementations, apparatus 820 may further include a memory 824 coupled to processor 422 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a UE (e.g., UE 110), and apparatus 820, as a network node (e.g., network node 125) of a network (e.g., network 120 as a 5G/NR mobile network), is provided below in the context of example process 900.

### Illustrative Processes

Process 900 may represent an aspect of implementing various proposed designs, concepts, schemes, systems and methods described above pertaining to D2C satellite mode selection between NTN and TN in wireless communications, whether partially or entirely, including those pertaining to those described above. Each process may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or alternatively in a different order. Furthermore, one or more of the blocks/sub-blocks of each process may be executed iteratively.

FIG. 9 illustrates an example process 900 in accordance with an implementation of the present disclosure. Solely for illustrative purposes and without limiting the scope, process 900 is described below in the context of apparatus 810 as a lab equipment (e.g., a computer in a lab) and apparatus 820 as a communication entity such as a UE (e.g., UE 110) or a base station (e.g., network node 125) of a network. Process 900 may begin at block 910.

At 910, process 900 may involve processor 812 of apparatus 810 (e.g., as UE 110) entering, via transceiver 816, a satellite mode due to no terrestrial coverage. Process 900 may proceed from 910 to 920.

At 920, process 900 may involve processor 812 performing, via transceiver 816, a procedure to shorten a search time or reduce power consumption, or both shorten the search time and reduce power consumption.

In some implementations, in performing the procedure, process 900 may involve processor 812 performing a satellite recovery procedure instead of a higher-priority PLMN search procedure.

In some implementations, in performing the satellite recovery procedure, process 900 may involve processor 812 performing certain operations. For instance, process 900 may involve processor 812 applying a timer for an OOS recovery procedure. Moreover, process 900 may involve processor 812 removing an “any PLMN” search.

Alternatively, or additionally, in performing the satellite recovery procedure, process 900 may involve processor 812 performing other operations. For instance, process 900 may involve processor 812 performing a satellite mode procedure on a first set of RF components. Additionally, process 900 may involve processor 812 performing an OOS recovery procedure on a second set of RF components.

In some implementations, in performing the satellite recovery procedure, process 900 may involve processor 812 applying an AI satellite hiking mode when performing an OOS recovery search with a satellite band or frequency excluded. In some implementations, in applying the AI satellite hiking mode, process 900 may involve processor 812 reducing a search range by detecting whether there is power variance in each searched band.

In some implementations, in performing the satellite recovery procedure, process 900 may involve processor 812 performing both a first procedure and a second procedure. The first procedure may involve performing a satellite recovery procedure instead of a higher-priority PLMN search procedure. The second procedure may involve applying an AI satellite hiking mode when performing an OOS recovery search with a satellite band or frequency excluded. In some implementations, in applying the AI satellite hiking mode, process 900 may involve processor 812 reducing a search range by detecting whether there is power variance in each searched band.

In some implementations, in performing the satellite recovery procedure, process 900 may involve processor 812 performing a PLMN search procedure using an optimized PLMN search sequence for satellite by: (a) removing a satellite band or frequency from a full band scan of a first type of network technology (e.g., 4G); and (b) appending the satellite band or frequency to an end of a full band scan of a plurality of types of network technologies including the first type of network technology (e.g., 6G/5G/4G/3G/2G).

Alternatively, or additionally, in performing the satellite recovery procedure, process 900 may involve processor 812 performing a PLMN search procedure using an optimized PLMN search sequence for satellite by: (a) removing a satellite band or frequency from a full band scan of a first type of network technology (e.g., 4G); and (b) inserting the satellite band or frequency to a middle of a full band scan of a plurality of types of network technologies including the first type of network technology (e.g., 6G/5G/4G/3G/2G).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering, by a processor of a user equipment (UE), a satellite mode due to no terrestrial coverage; and
performing, by the processor, a procedure to shorten a search time or reduce power consumption, or both.

2. The method of claim 1, wherein the performing of the procedure comprises performing a satellite recovery procedure instead of a higher-priority public land mobile network (PLMN) search procedure.

3. The method of claim 2, wherein the performing of the satellite recovery procedure comprises:
applying a timer for an out of service (OOS) recovery procedure; and
removing an “any PLMN” search.

4. The method of claim 2, wherein the performing of the satellite recovery procedure comprises:
performing a satellite mode procedure on a first set of radio frequency (RF) components; and
performing an out of service (OOS) recovery procedure on a second set of RF components.

5. The method of claim 1, wherein the performing of the procedure comprises applying an artificial intelligence (AI) satellite hiking mode when performing an out of service (OOS) recovery search with a satellite band or frequency excluded.

6. The method of claim 5, wherein the applying of the AI satellite hiking mode comprises reducing a search range by detecting whether there is power variance in each searched band.

7. The method of claim 1, wherein the performing of the procedure comprises performing both a first procedure and a second procedure, and wherein:
the first procedure comprises performing a satellite recovery procedure instead of a higher-priority public land mobile network (PLMN) search procedure; and
the second procedure comprises applying an artificial intelligence (AI) satellite hiking mode when performing an out of service (OOS) recovery search with a satellite band or frequency excluded.

8. The method of claim 7, wherein the applying of the AI satellite hiking mode comprises reducing a search range by detecting whether there is power variance in each searched band.

9. The method of claim 1, wherein the performing of the procedure comprises performing a public land mobile network (PLMN) search procedure using an optimized PLMN search sequence for satellite by:
removing a satellite band or frequency from a full band scan of a first type of network technology; and
appending the satellite band or frequency to an end of a full band scan of a plurality of types of network technologies including the first type of network technology.

10. The method of claim 1, wherein the performing of the procedure comprises performing a public land mobile network (PLMN) search procedure using an optimized PLMN search sequence for satellite by:
removing a satellite band or frequency from a full band scan of a first type of network technology; and
inserting the satellite band or frequency to a middle of a full band scan of a plurality of types of network technologies including the first type of network technology.

11. An apparatus implementable in a user equipment (UE), comprising:
a transceiver configured to communicate wirelessly; and
a processor coupled to the transceiver and configured to perform operations comprising:
entering, via the transceiver, a satellite mode due to no terrestrial coverage; and
performing, via the transceiver, a procedure to shorten a search time or reduce power consumption, or both.

12. The apparatus of claim 11, wherein the performing of the procedure comprises performing a satellite recovery procedure instead of a higher-priority public land mobile network (PLMN) search procedure.

13. The apparatus of claim 12, wherein the performing of the satellite recovery procedure comprises:
applying a timer for an out of service (OOS) recovery procedure; and
removing an “any PLMN” search.

14. The apparatus of claim 12, wherein the performing of the satellite recovery procedure comprises:
performing a satellite mode procedure on a first set of radio frequency (RF) components; and
performing an out of service (OOS) recovery procedure on a second set of RF components.

15. The apparatus of claim 11, wherein the performing of the procedure comprises applying an artificial intelligence (AI) satellite hiking mode when performing an out of service (OOS) recovery search with a satellite band or frequency excluded.

16. The apparatus of claim 15, wherein the applying of the AI satellite hiking mode comprises reducing a search range by detecting whether there is power variance in each searched band.

17. The apparatus of claim 11, wherein the performing of the procedure comprises performing both a first procedure and a second procedure, and wherein:
the first procedure comprises performing a satellite recovery procedure instead of a higher-priority public land mobile network (PLMN) search procedure; and
the second procedure comprises applying an artificial intelligence (AI) satellite hiking mode when performing an out of service (OOS) recovery search with a satellite band or frequency excluded.

18. The apparatus of claim 17, wherein the applying of the AI satellite hiking mode comprises reducing a search range by detecting whether there is power variance in each searched band.

19. The apparatus of claim 11, wherein the performing of the procedure comprises performing a public land mobile network (PLMN) search procedure using an optimized PLMN search sequence for satellite by:
removing a satellite band or frequency from a full band scan of a first type of network technology; and
appending the satellite band or frequency to an end of a full band scan of a plurality of types of network technologies including the first type of network technology.

20. The apparatus of claim 11, wherein the performing of the procedure comprises performing a public land mobile network (PLMN) search procedure using an optimized PLMN search sequence for satellite by:
removing a satellite band or frequency from a full band scan of a first type of network technology; and
inserting the satellite band or frequency to a middle of a full band scan of a plurality of types of network technologies including the first type of network technology.
